(19) United States
(12) Patent Application Publication
(10) Pub. No.: US 2020/0029508 A1
(43) Pub. Date: Jan. 30, 2020

(54) Vertical urban garden

(71) Applicant: Alejandro Vazquez Losada, London (GB)

(72) Inventor: Alejandro Vazquez Losada, London (GB)

(21) Appl. No.: 16/047,028

(22) Filed: Jul. 27, 2018

(51) Int. Cl. A01G 9/20; A01G 31/06; A01G 9/02; A01G 9/24; A01G 7/04; A01G 27/00

(52) U.S. Cl. CPC A01G 9/20; A01G 31/06; A01G 9/02; A01G 27/001; A01G 9/246; A01G 7/045; A01G 9/247

(57) ABSTRACT

The urban vertical garden of this realization is formed by a structure with a modular system of scaffolding, a wood or other structural system formed by pipes, preferably of galvanized steel and that makes up a set of cultivation modules placed vertically, where each module has at least a bench terrace filled with soil and connected to an automated drip irrigation system, at least one wall for vertical cultivation normally hydroponic formed by horizontal trays situated at different levels; possibility of including two aeroponic towers with an internal irrigation system, at least one water tank situated in the upper module, and at least one pump in the bottom level.

### CROSS-REFERENCE TO RELATED APPLICATIONS

Not applicable

### STATEMENT REGARDING FEDERALLY SPONSORED RESEARCH OR DEVELOPMENT

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### BACKGROUND OF THE INVENTION TECHNICAL FIELD

Urban gardens have existed since urban planning was created, but they began to be popularized in the Second World War, since they were used in cities of the United States, where they managed to produce 40% of the food during a difficult period in which food was scarce, and they were an excellent form of generating local food in order to supply the large urban cities. In recent years, interest in cultivation systems has been increasing, particularly, but not exclusively, in cities and urbanized areas.

This invention reveals the development of a dismountable garden, used for the production of food in vertical form in urban areas. It encourages the use of spaces and recycled materials, in order to achieve a reconnection of the city with nature.

The invention is based on production models, using a minimal useful area and taking advantage to the maximum of solar energy through an efficient design. With it you obtain an optimization in the production of fresh food and a minimal expense of drinking water. Urban agriculture entails an improvement in the health of the inhabitants of the large cities, since it provides an increase in the green urban surface area, energy efficiency, as well as favouring the consumption of local food, the efficient management of waste, and the reduction of pollution associated with the transport of food.

Under these precepts, education in agriculture and healthy nutrition is promoted, generating a local identity and the social inclusion of neighbours. The invention is centred on ecological production and permaculture, where the use of chemicals or pesticides is minimized. Food produced can be consumed or distributed locally, generating new commercialization circuits and the development of the local economy, for which reason it also favours local employment and the revalorization of the land.

In the state of the art there are transportable gardens that present a series of drawbacks, which for example do not manage to use efficiently the water coming from rain or from irrigation that is provided to their cultivation soil.

In the state of the art, the Spanish utility model U201100309 refers to a transportable garden that includes a transportable container of soil. This container is formed by a first bottom base and four first side walls, and is used for placing soil in its interior in a sufficient quantity to permit the cultivation of vegetables. The transportable garden also includes a second space containing water delimited between this first bottom base and a second bottom base, and, optionally, between the four first side walls and four second side walls that delimit the exterior of the urban garden. In addition, according to the invention the first base can be permeable, so that the rain and irrigation water is filtered through the soil and is stored in this second space, accumulating it for its later use for any appropriate purpose, for example, the irrigation of the cultivation soil itself. Between the second base and the first based there can be support means of the first base, such as a partition, continuous or discontinuous. Optionally, the urban garden can be modular, and include an accessory recipient with one or more cavities, and the container recipient of soil as well as the accessory recipient can have, respectively, a cover.

This invention described herein presents many advantages with respect to the traditional urban gardens executed vertically by means of a scaffolding structure, a bamboo or other type of modular structural system, where fresh food is cultivated on the different horizontal platforms that comprise it. The modular design provides it flexibility in four dimensions, with which it can be adapted to different places and climates. It is designed for large urban cities through the use of spaces such as façades and dividing walls existing with a correct orientation for the maximum solar use.

The production of food is done through a combination of traditional and modern systems, where bench terraces of soil and hydroponic/aquaponic systems are used, in addition to the possibility of adding an aeroponic system. For the cultivation, positive associations of different varieties can be used, prioritizing the cultivation of seasonal crops and local varieties, with automatic irrigation control. In cold climates, the façade can be covered with a plastic or glass in order to create a greenhouse effect in its interior, where the ventilation, lighting and temperature can also be controlled.

### BRIEF SUMMARY OF THE INVENTION

This invention reveals a dismountable urban garden, executed vertically by means of a scaffolding structure, a bamboo or other type of modular structure, where fresh food is cultivated on the different horizontal platforms that comprise it. The modular design provides flexibility as to the dimensions, with which it can be adapted to different places and climates.

### BRIEF DESCRIPTION OF THE DRAWINGS

To complement the description that is being made and for the purpose of aiding a better understanding of the characteristics of the invention, in accordance with a preferred example of the practical realization thereof, a set of drawings is attached as an integral part of said description, where it includes but is not limited to, the following:

FIG. 1 shows a frontal view of the bench terrace (15).

FIG. 2 shows a frontal view of the aeroponic tower (16).

FIG. 3 shows a frontal view of the wall (17) with the cultivation modules (18).

FIG. 4 shows a view of the scaffolding assembly (10).

FIG. 5 shows a view of the scaffolding with the formwork boards (12), the metallic grating (13) for the floor, and the solar panel (14).

FIG. 6 shows a view of the garden with the placement of the aeroponic towers (16), the hydroponic wall (17) on the main face, and the cultivation modules (18).

FIG. 7 shows a view of the garden with the placement of plants (19).

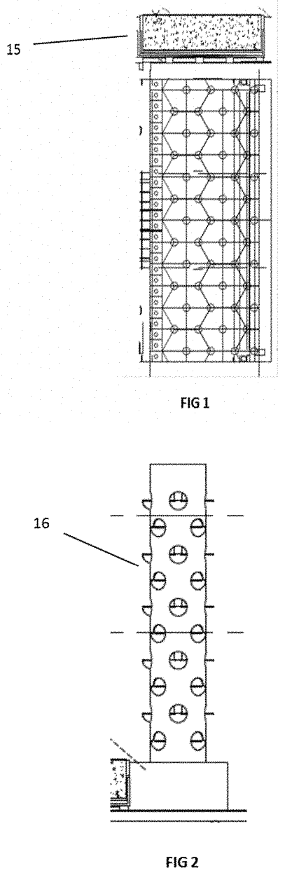

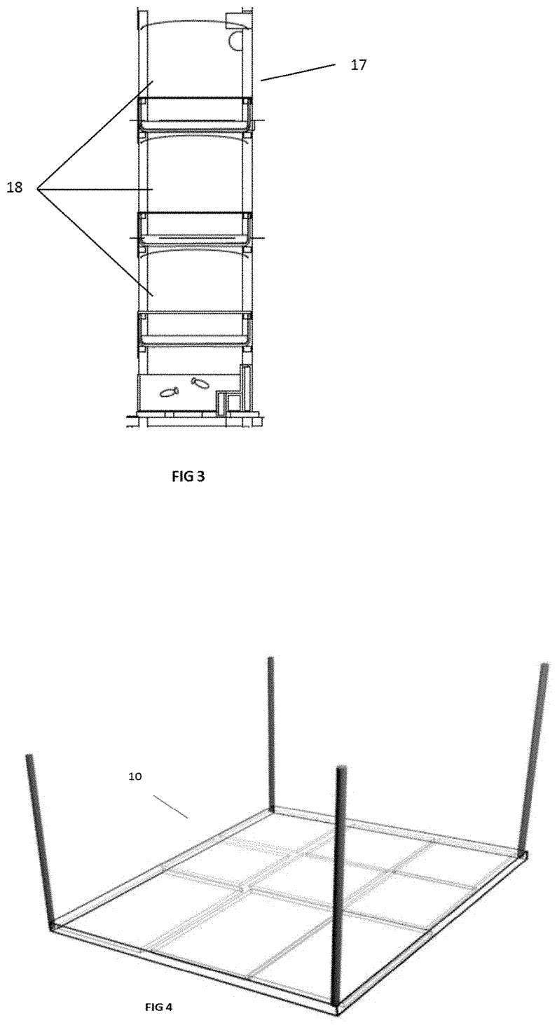

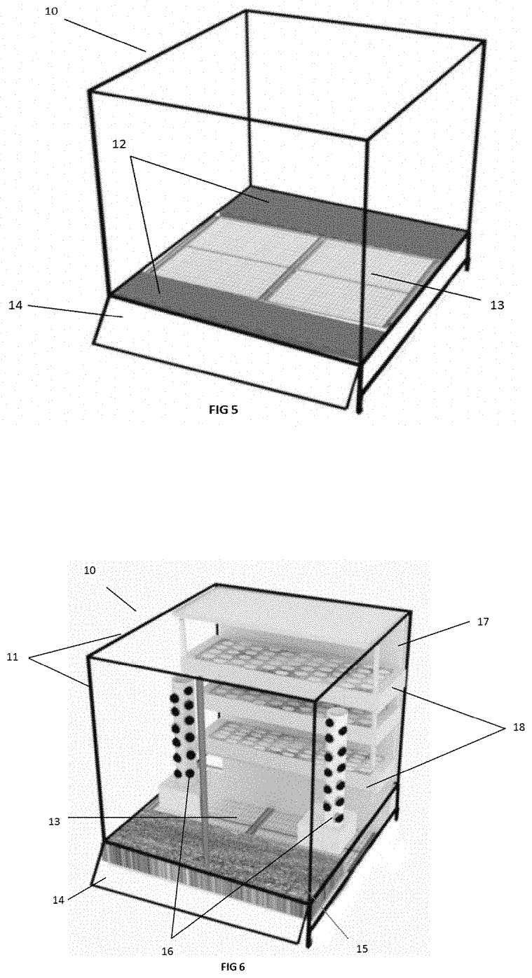

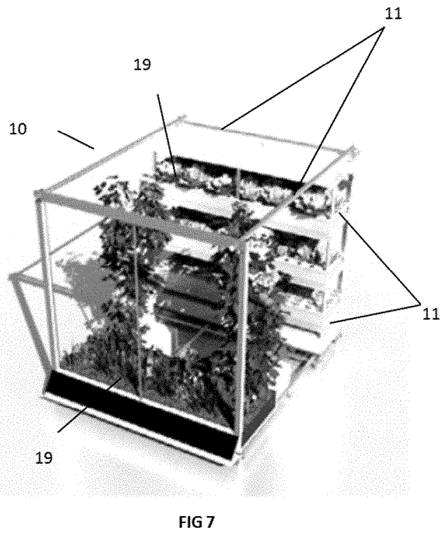

### DETAILED DESCRIPTION OF THE INVENTION

This invention reveals a dismountable garden, executed in vertical form through a scaffolding structure, a bamboo or other type of modular structural system, where fresh food is grown on the different horizontal platforms that comprise it. The modular design provides it with flexibility regarding dimensions, with which it can be adapted to different places and climates. It is designed for large urban cities by means of the use of spaces such as façades and dividing walls existing with a correct orientation for the maximum use of solar resources.

Food production is accomplished through a combination of traditional and modern systems, where bench terraces of soil, hydroponic aquaponic systems are used, as well as the possibility of adding an aeroponic system. In the cultivation, positive associations of different varieties can be used in cultivating seasonal products and local varieties, with an automatic irrigation control. The use of bees and insects will be encouraged as a tool for controlling pests. In cold climates the façade can be covered with a plastic or glass to create the greenhouse effect in the interior, where the ventilation, lighting and temperature an also be controlled.

The production of the vertical garden is developed in modules that are presented as planting cubicles, designed to let the maximum natural solar light pass and permit the movement of people. Each module measures around two metres in width and has a bench terrace of soil on the exterior side, some aeroponic towers in the middle part (which can be substituted by a bench terrace) and a vertical cultivation shelf (usually hydroponic) in the part next to the existing wall.

The irrigation can be automated both in the hydroponic cultivation (the water falling by gravity), and for the bench terraces through drip pipes from the accumulation tanks, passing through a boost pump.

The horizontal and vertical circulation allows the workers to move around, who can handle the crops without the needs for harnesses or personal protection equipment.

### DESCRIPTION OF THE PREFERRED EMBODIMENT

The vertical garden of this realization is formed by a structure with a modular scaffolding system, a wood or other structural system (10) formed by pipes (11), preferably of galvanized steel, and which includes a set of cultivation modules (18) placed vertically, where each module (18) has at least one bench terrace (15) filled with soil and connected to an automated drip irrigation system, at least one wall for vertical cultivation (17), normally hydroponic formed by horizontal trays placed at different levels; the possibility of including two aeroponic towers (16) with an interior irrigation system, at least one water tank situated in the upper module, and at least one pump on the ground floor.

Each cultivation module (18) is presented as an “independent” system that could supply food for a family. It can be built in situ or in a factory and transported to the assembly site. The basic standard module (18) is comprised of a bench terrace (15), possibility of including two aeroponic towers (16) and at least one wall of vertical cultivation, normally hydroponic (17). A more economical variant of the module is to substitute the aeroponic towers (16) by a bench terrace (15) of soil with drip irrigation. The width of the model can vary between 2.00 and 2.25 metres, while the length can vary between 1.20 and 4.00 metres depending on the needs, the useful space and the assumable weight at floor level.

The bench terrace (15) is a planter made with PVC or wooden boards with waterproofing plastic. It is filled with soil, watered by means of an automatic drip irrigation system that will have a tank and pump which are independent from the hydroponic system. These will not need additional nutrients since they will be added to the water that comes from the compost bin.

The vertical cultivation wall (17) is a set of shelves with horizontal trays or cultivation modules (18), for planting at different levels, which can use a hydroponic system or with soil substrate. A support of artificial light can also be incorporated. The vertical cultivation walls receive water from the top module and it goes descending vertically through the modules until reaching the bottom shelf, where it is accumulated in a tank and depending on the type of garden, it can include an aquaponic system to generate nutrients naturally or provide nutrients artificially. From there and once water is accumulated with new nutrients, it passes to the pressure pump that will take the water to the last level where the second accumulator will be located which will again begin the process.

The aeroponic tower (16) is a vertical tower of PVC for cultivating lettuce and strawberries through the plant openings. The aeroponic tower incorporates an internal irrigation system of the tower where the roots of the plants are found and the water falls by gravity, passing through the different modules.

The shape of the system has a rectangular layout and generally also in its elevation, although it is adaptable to different geometries, due to the flexibility of the modular system. The transversal section of the project does not have large variations overall in order to optimize the use of sunlight, while its longitudinal dimensions can vary depending on the dimensions of the façade, creating quite varied shapes.

The set of modules that form the garden are placed vertically, forming a new “wall” on the existing façade, which can be mounted and dismounted easily. The height of the modules is fixed, while the total height of the garden set can vary according to the number of levels of modules installed, which will depend on the height of the existing façade.

The typical structure is a modular scaffolding system (10), formed by galvanized steel pipes (11) of 48 mm in diameter, although the structural system can vary depending on the area where it is located, being able to be a structure with another type of metal, wood, bamboo, etc. A metallic reticulated grating (13) is included to create the floor of the module, and which at the same time lets the sunlight pass to the lower plants.

The vertical garden can be thermally open or closed. In the cold months of winter, one can install a plastic or glass cover (which can be permanent if it deals with a very cold climate), through which a thermal balance is maintained that will benefit the production. This cover generates the greenhouse effect inside it, being able to consider the garden as a “vertical greenhouse” during the winter, with the objective of controlling and establishing the optimal environment for the cultivation in cold climates or in the winter. The garden can incorporate a system that allows the regulation of the temperature, the humidity and light. In addition it provides a protection against diseases, infestations or other pests, since a greenhouse is a watertight space. Its greatest advantage is generating greater production, since thanks to the climate conditions, it can accelerate the growth of the plants, it can cultivate products outside their season, and consequently, achieve a better selling price and a continuous supply of the product. On the other hand, the system optimizes the use of other technologies to facilitate climate management (heating, humidifying, shade screens or energy savings, etc.). The thermal closing is done with transparent plastic or glass in order to let the light pass to the crops.

Solar panels can be included in the lower part of each module (found in the bench terrace of soil) by means of a special part that forms the inclination of the solar panel, while letting the ventilation pass. The generated photovoltaic energy goes to a battery that will electrically drive the water pressure pumps.

The access to the garden is produced from the bottom level, where the ladders for vertical movement are available, which can vary their position with respect to the overall, depending on the characteristics of the site and will have access restricted to the garden workers or educational groups. The vertical garden allows the interior movement of the workers through the aisles in order to reach the different modules horizontally, and also they can reach the different levels vertically through the vertical circulation modules. These vertical circulation modules have a ladder of variable size depending on the number of heights, the number of modules and the total dimensions of the set. They also have a lift that can be manual or mechanical for the vertical movement of the products between different levels.

The bottom level can have an anti-theft lock, which, depending on the dimensions and the location of the garden, can be a metallic reticulated grating that will be anchored to the scaffolding pipes when the garden is not functioning. A metal roller blind can also be installed that will completely close the bottom level and guarantee that no possible thefts or undesired intrusions to the garden take place.

The harvested crops are taken to the bottom level through an electric or manual service lift, where they will be temporarily accumulated, to later be dispatched. The harvested crops will be stored protected from the sun, but they can be exhibited to possible clients. The sale of prepared salads to take away will be prioritized, with which greater benefits will be achieved.

When the owner requires it, the bottom level can have a table and the necessary furnishing to tend the clients, prepare salads or work with the seeds. This level can also have a container that is exposed to the street as a deposit of organic waste. In it can be deposited the organic waste and it will be where the compost is created for the bench terraces, transforming it in nutrients for the garden.

The steps to follow for the formation of the vertical garden are:

1. Assembly of the modular structure (10) with the placement of the pipes (11).

2. Placement of the wooden boards (12), the metallic grating (13) for the floor and the solar panel (14).

3. Construction of the bench terrace (15) with waterproof wood and plastic, substitutable by manufactured PVC.

4. Placement of the aeroponic towers (16) or otherwise a bench terrace (15).

5. Placement of a hydroponic wall (17) in the principal face and the cultivation modules (18).

6. Placement of the compost and irrigation systems.

7. Filling with water.

8. Placement of plants (19) and seedbeds.

There are four types of modules depending on the dimensions and available financing, therefore, the production form will also depend on this.

Each module produces the amount of food necessary to supply the needs of at least one person. Although it depends on its location, when the glass or plastic cover is incorporated to create the greenhouse effect, the production increases in large measure during the winter months. Each module can be built in situ or in a factory and transported.

The materials that form the modules can vary depending on the economy, so that the bench terraces of soil can be in a container of wood built “in situ” or be of plastic manufactured in a factory.

A waterproof sheet is where the system meets the existing façade, to create an extra protection against humidity and water that could affect the façade. Therefore, the existing façade is fully protected, even more than without the vertical garden.

Wood is used for the solid closures of the bottom level, the construction of the bench terraces, the side elevations of the garden and the interior furnishings (although this can vary depending on the project's budget, being able to sue other materials such as plastic for these purposes).

If the finishes are of wood, in the more vulnerable areas a layer of varnish will be applied to protect the wood and follow the criteria of comfort and durability. The hydroponic shelves will also be covered with a laminated board that will provide an aesthetic unity to the interior finishes.

The water that enters in the system is reused cyclically until the plants absorb it completely or it evaporates; therefore, the system will not waste water and a direct connection with the public sewer system is not needed.

The water introduced by rain or from the point of consumption is taken to a tank in the top level, where it will be accumulated and distributed through the garden automatically. On the bottom level, another water accumulation tank is located with a pressure pump that will take the water to the last level of the garden.

The irrigation water will fall vertically by gravity through the different levels, being collected at the bottom level, where it will be treated and accumulated to again take it to the top level, creating a closed circuit.

The ventilation is produced by convection when the garden is closed, with a circulation of natural air from below upwards. The system can have support ventilators when the solar panels provide sufficient electrical power or in case of having access to an electrical supply.

The irrigation system (just like that of support lighting and ventilation, if any) will be controlled by an automated system that will send the information to an application and can be controlled from a mobile telephone. The application guarantees the control and supervision of the crops, as well as the amount of water in the system and its pH.

1. Urban vertical garden comprising
a structure with a modular scaffolding system
an upper module that contains a water tank
a set of cultivation cubicles placed vertically, where each cubicle comprises:
a wall of vertical hydroponic cultivation formed by horizontal trays called cultivation modules situated at different levels and formed by a bench terrace filled with soil and connected to an automated drip irrigation system;
at least two aeroponic towers (16) with internal irrigation system;
at least one water tank situated in it;
a lower module that contains a pump, storage space, manipulation and distribution

2. Urban vertical garden according to claim 1 wherein the bench terrace (15) has a tank and independent pump.

3. Urban vertical garden according to claim 1 wherein the vertical cultivation wall (17) incorporates artificial light.

4. Urban vertical garden according to claim 1 wherein the vertical cultivation wall (17) can include an aquaponic system.

5. Urban vertical garden according to claim 1 wherein the scaffolding (10) is formed by galvanized steel pipes (11).

6. Urban vertical garden according to claim 1 where the bottom of each module includes a metallic reticulated or glass grating (13) that allows the passing of sunlight to the lower plants.

7. Urban vertical garden according to claim 1 where the garden incorporates a plastic or glass cover.

8. Urban vertical garden according to claim 1 where the garden incorporates a system to regulate the temperature, humidity and light.

9. Urban vertical garden according to claim 1 where the access to the garden is done from the ground floor, where there are ladders for vertical movement.

10. Urban vertical garden according to claim 1 where the vertical garden incorporates aisles that communicate horizontally with the different cultivation modules (18), and vertically with the different levels through the vertical circulation modules by means of ladders of variable size.

11. Urban vertical garden according to claim 1 where the vertical garden incorporates a lift that can be manual or mechanical.

12. Urban vertical garden according to claim 1 where the bottom module incorporates an anti-theft lock.

13. Urban vertical garden according to claim 1 where the garden incorporates a solar panel (14).

14. A method of assembly for an urban vertical garden that comprises the following steps:
assembly of the modular structure with the placement of the pipes placement of the wooden boards, the metallic grating for the lower module and the solar panel
construction of the bench terraces with waterproofed wood and plastic, substitutable by manufactured PVC.
placement of the aeroponic towers or otherwise a bench terrace
placement of the hydroponic wall on the principal face and the cultivation modules
placement of the compost and irrigation systems.
filling water tanks with water.
placement of plants and seedbeds.
